(19) United States
(12) Patent Application Publication
(10) Pub. No.: US 2015/0296023 A1
(43) Pub. Date: Oct. 15, 2015

(54) BIOLOGICAL INFORMATION COLLECTING AND DELIVERING SYSTEM

(71) Applicant: Hitachi Systems, Ltd., Tokyo (JP)

(72) Inventor: Akira Rokkaku, Shinagawa-ku (JP)

(21) Appl. No.: 14/438,911

(22) PCT Filed: Oct. 31, 2012
(86) PCT No.: PCT/JP2012/078159

§ 371 Date: Apr. 28, 2015

(51) Int. Cl. H04L 29/08; H04L 29/06

(52) U.S. Cl. CPC H04L 67/125; H04L 67/42

(57) ABSTRACT

A biological information collecting and delivering system for appropriately delivering plural types of biological information obtained from a sensor to a referencing party according to the type, content, and the like. In a representative embodiment of the present invention, a biological information acquiring device 10, a biological information transferring device 20 that acquires the biological information from the biological information acquiring device 10, a collecting and delivering server 30 that collects the biological information from the biological information transferring device 20 and records the analyzing information for every biological information acquiring device 10, and an analyzing information display device 40 that records the analyzing information delivered from the collecting and delivering server 30 and presents the analyzing information to the user are arranged, and the collecting and delivering server 30 includes a distribution rule 34 having a determination criteria of a value of an analysis result for every type of the biological information contained in the analyzing information and information of the analyzing information display device 40 to become a destination for delivering the analyzing information when all the determination criteria are met, and a distribution determining unit 33 that determines the analyzing information display device 40 to be delivered based on the value for every type of biological information contained in the analyzing information and the distribution rule 34.

### CROSS REFERENCE TO RELATED APPLICATIONS

This application is entitled to the benefit of and incorporates by reference subject matter disclosed in International Patent Application No. PCT/JP2012/078159 filed on Oct. 31, 2012.

### TECHNICAL FIELD

The present invention relates to techniques that handle biological information of an individual, and in particular, relates to a technique that is effective when applied to a biological information collecting and delivering system that collects plural types of biological information of a plurality of users, and manages the state of each user in an integrated fashion.

### BACKGROUND ART

In recent years, with miniaturization and higher precision degree of a sensor, for example, a compact device equipped with various types of sensors is attached to a human, an animal, and the like to acquire and record the biological information. The biological information can be referenced by each individual. Furthermore, a service in which the recorded biological information is transferred to a server through a network and aggregated so that a healthcare facility, a business operator of a care service, and the like manage and monitor a health state and an active state of each individual based on the biological information, for example, is also provided.

For example, Japanese Patent Application Laid-Open Publication No. 2008-40761 discloses a technique related a disease predicting management service including a detection means that detects change in a normal state and an abnormal state of biological data of a specific managing site of a body of a service user; a communication means that collects the biological data regardless of whether the service user is inside or outside the home or the care facility and transmits the biological data to a communication network; a data processing means that acquires the biological data of all service users from the communication network for 24 hours in real time to create the biological information by a predetermined format and accumulate the data in a database; a data managing means that medically analyzes the biological information to create an electronic chart by a predetermined format and accumulate in the database; and a care emergency means that exercises the emergency according to the individual care and the situation of the service user whose biological change suddenly changed or exceeded a reference value compared to the normal time based on the electronic chart.

Japanese Patent Application Laid-Open Publication No. 2005-279051 discloses a technique in which a biological information collecting device collects the biological information of a user A, a user terminal transmits the biological information to a processing server, and the processing server carries out a diagnosis on the biological information based on a predetermined algorithm, accumulates the diagnosis result and stores a transmitting destination and a transmitting condition (transmission timing and transmission content) of the biological information and the diagnosis result, and transmits the information of the content specified for the transmitting destination (insurance company, caring company, etc.) corresponding to the transmitting condition to receive the desired service.

Japanese Patent Application Laid-Open Publication No. 2005-329111 discloses a technique of a biological information managing system including a biological information measuring device that is attached to a body of a measurement subject to measure the biological information of the measurement subject, a home server that accumulates the biological information and creates an outline information indicating the outline of the biological information, a center server that accumulates the outline information, and a terminal device that acquires the outline information and the biological information, where the biological information measuring device receives the biological information transmitted from an installing-type biological information measuring device through a wireless communication unit, and transmits the biological information to the home server with identification information of the measurement subject read out from a storage unit.

### SUMMARY

As acquisition and collection of plural types of biological information become possible with enhancement in sensor technology, the type of people, organization, business operators, and the like that use such collecting results, analysis results thereon, and the like also increase. Furthermore, the type of biological information required by the organizations, the business operators, and the like may obviously differ. For example, the content of the required biological information and the timing such content is required differ between the organizations that carry out services of managing and monitoring the active situations, the health states, and the like of individuals on a constant basis, and the doctors and security companies that respond at time of abnormality. Moreover, for example, the content of the biological information required on a steady basis may differ even in the information required by healthcare facilities depending on the purpose of management and monitoring (e.g., prevention for lifestyle related disease, etc.).

With regards to such aspect, in the conventional technique, the biological information is detected from each individual and transmitted to the server and the like, and such biological information is analyzed and the like to provide various types of services. Basically, notification is made to the relevant people, organizations, and the like when a specific condition is met (time of abnormality etc.) while carrying out monitoring on a steady basis at one place. Consideration is not greatly made in appropriately delivering and distributing to a plurality of people, organizations, and the like requiring the information in accordance with the type, content, and the like of the biological information acquired from plural types of sensors. In other words, a sensor (device) and a referencing party (business operator installing the sensor, etc.) of the biological information acquired by the sensor are in one to one correspondence, and for example, the system lacks in expandability and flexibility as the system for managing the obtained biological information needs to be individually built each time a type of sensor (business operator installing the same, etc) is added.

It is an object of the present invention to provide a biological information collecting and delivering system that appropriately delivers the plural types of biological information obtained from the sensor to the referencing party requiring the biological information or to be provided with the biological information in accordance with the type, content, and the like thereof. The above-mentioned purpose as well as other purposes and novel characteristics of the present invention shall become apparent from the description of the present specification and the accompanying drawings.

Among the inventions disclosed in the present application, the outline of the representative invention will be hereinafter briefly described.

A biological information collecting and delivering system according to a representative embodiment of the present invention is a biological information collecting and delivering system including a biological information acquiring device attached to a user to acquire the biological information of the user, a biological information transferring device that acquires the biological information from one or more biological information acquiring devices and records the biological information, a collecting and delivering server that collects the biological information from one or more biological information transferring devices and records the biological information, analyzes the recorded biological information, and records the analyzing information for every biological information acquiring device, and an analyzing information display device that receives and records the analyzing information delivered from the collecting and delivering server and presents the analyzing information to the user. The biological information collecting and delivering system has the following characteristics.

The collecting and delivering server includes a distribution rule including a determination criteria of a value of an analysis result for every type of biological information contained in the analyzing information, and information of one or more analyzing information display devices to become a destination for delivering the analyzing information when all of the determination criteria are met, and a distribution determining unit for determining the analyzing information display device to deliver the analyzing information based on a value for every type of biological information contained in the analyzing information and the distribution rule.

The effects obtained from the representative embodiment of the invention disclosed in the present application will be briefly described below.

According to the representative embodiment of the present invention, the plural types of biological information obtained from the sensor can be appropriately delivered to the referencing party requiring the biological information or providing the biological information according to the type, content, and the like thereof.

### BRIEF DESCRIPTIONS OF THE DRAWINGS

FIG. 1 is a view showing an outline for a configuration example of a biological information collecting and delivering system according to one embodiment of the present invention;

FIG. 2 is a view showing an outline of an example of a data configuration of biological information TB (and biological information) and specific data in one embodiment of the present invention;

FIG. 3 is a view showing an outline of an example of a data configuration of analyzing information TB and specific data in one embodiment of the present invention;

FIG. 4 is a view showing an outline of an example of a data configuration of a distribution rule and specific data in one embodiment of the present invention;

FIG. 5 is a flowchart showing an outline of an example of a flow of the determination process of the delivery destination of the analyzing information in one embodiment of the present invention;

FIG. 6 is a flowchart showing an outline of an example of the flow of the duration time calculating process in one embodiment of the present invention;

FIG. 7 is a flowchart showing an outline of an example of the flow of the analyzing information coupling requesting process in one embodiment of the present invention;

FIG. 8 is a flowchart showing an outline of an example of the flow of the analyzing information coupling process in one embodiment of the present invention;

FIG. 9 is a flowchart showing an outline of an example of the flow of the analyzing information and coupling analyzing information coupling process in one embodiment of the present invention; and

FIG. 10 is a flowchart showing an outline of an example of the flow of the coupling information clearing process in one embodiment of the present invention.

### DETAILED DESCRIPTION

Embodiments of the present invention will be hereinafter described in detail based on the drawings. Throughout the figures for describing the embodiments, the same reference numerals are, in principle, denoted on the same units, and the repetitive description will be omitted.

A biological information collecting and delivering system according to one embodiment of the present invention is a system of attaching a device including a sensor capable of acquiring a plurality of biological information to a user individual, aggregating the obtained biological information in the server in an integrated fashion, analyzing each biological information on the server to grasp an index for the health state, the active situation, and the like, delivering such information at an appropriate timing to people, organizations, and the like requiring such information based on the analysis result.

Thus, for example, abnormality indication can be automatically detected for a plurality of services requiring the plural types of sensor information such as care service of elderlies, managing/monitoring service of various types of diseases such as lifestyle related diseases, and the like, and such information can be automatically delivered to an appropriate specialized institution, a business operator, and the like.

<System configuration>

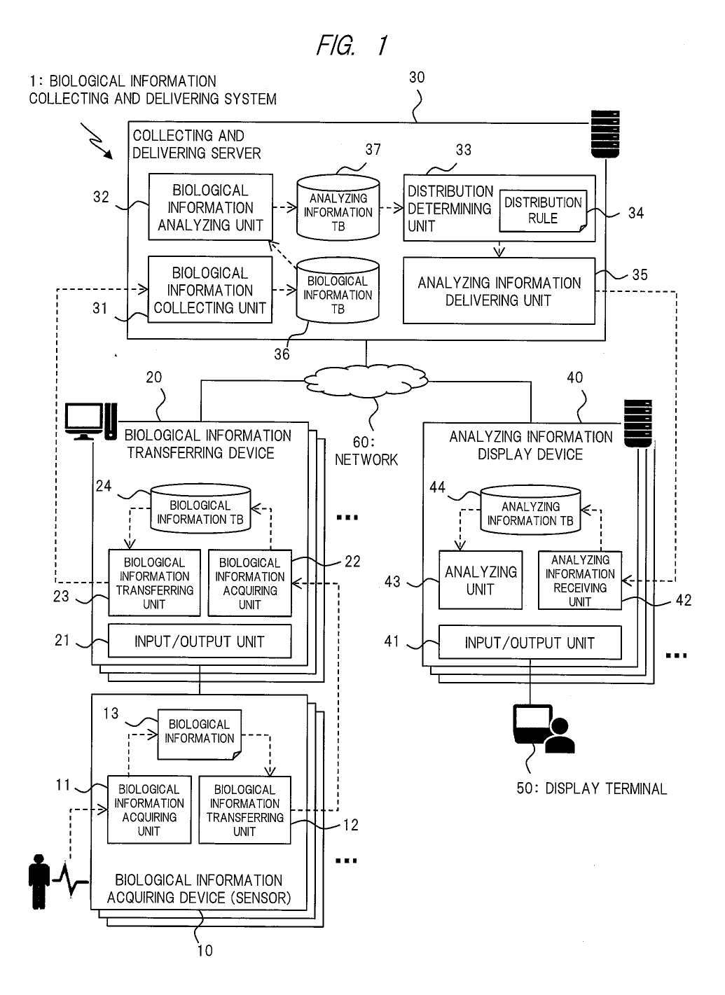

FIG. 1 is a view showing an outline for a configuration example of a biological information collecting and delivering system according to one embodiment of the present invention. A biological information collecting and delivering system 1 is configured such that one or more biological information transferring devices 20 and one or more analyzing information display devices 40 can be connected to a collecting and delivering server 30 by way of a network 60 such as the Internet. One or more biological information acquiring devices (hereinafter sometimes simply referred to as “sensor”) 10 can be connected to each biological information transferring device 20. The connection between the biological information transferring device 20 and the sensor 10 may be established through a wired or a wireless network, or the sensor 10 may be directly connected through an input/output port or a dedicated cradle of the biological information transferring device 20.

The biological information acquiring device (sensor) 10 is a device that is attached to each user to acquire and detect the biological information in a normal life of the user, and for example, can be configured by appropriately using known techniques such as wrist band type device, and the like as described in patent document 3. The sensor 10 includes each unit such as, for example, a biological information acquiring unit 11 and a biological information transferring unit 12 mounted by software or hardware.

The biological information acquiring unit 11 carries out a process of detecting and recording the biological information 13 of the user, to whom the sensor 10 is attached, periodically at predefined intervals using one or more sensor devices (not shown). The type of biological information acquired here is not particularly limited, and for example, data that can be detected by the various types of sensor devices such as pulse rate and blood pressure can be used as the target in addition to three-dimensional acceleration data serving as information of movement, temperature (body temperature, environmental temperature), and the like. In the present embodiment, the three-dimensional acceleration data and the temperature are acquired. The acquired biological information 13 is, for example, recorded in a memory (not shown), and the like, and accumulated therein until at least transferred by the biological information transferring unit 12 to be described later.

The biological information transferring unit 12 carries out a process of acquiring the biological information from the memory, and the like and transmitting the biological information upon receiving a transfer instruction of the biological information 13 from the biological information transferring device 20, to be described later. At this time, the data of the biological information 13 that has been transmitted may be erased from the memory, and the like.

The biological information transferring device 20 is a device configured by an information processing device such as a PC (Personal Computer), etc. installed in homes, and the like of each user, and transfers the biological information 13 acquired by the sensor 10 to the collecting and delivering server 30, to be described later. The device includes, for example, each unit such as an input/output unit 21, a biological information acquiring unit 22, a biological information transferring unit 23, and the like mounted by software. A biological information table (TB) 24 mounted by a database, a file table, and the like is also provided.

The input/output unit 21 carries out a process of receiving an operation instruction from the user or displaying the content, and the like of the biological information TB24 to the user. The operation instruction may include an instruction for transferring the biological information 13 acquired and accumulated by the sensor 10 to itself, or an instruction for transferring the biological information 13 acquired from the sensor 10 and accumulated in the biological information TB 24 to the collecting and delivering server 30. The sensor 10 may be connected through a port, a cradle, or the like (not shown) to carry out a process of directly inputting the biological information 13.

The biological information acquiring unit 22 makes a transfer instruction of the biological information 13 with respect to the sensor 10 according to an instruction from the user through the input/output unit 21 or periodically at predefined intervals, and carries out a process of recording and accumulating the transferred biological information 13 in the biological information TB 24. The biological information transferring unit 23 also carries out a process of acquiring the biological information 13 accumulated in the biological information TB 24 and transmitting the information to the collecting and delivering server 30 according to the instruction from the user through the input/output unit 21 or periodically at predefined intervals. Here, for example, if the biological information 13 newly recorded in the biological information TB 24 from the previous transmission does not exist, the transmission process may not be carried out.

The collecting and delivering server 30 is a server system that collects the biological information 13 from the biological information transferring device 20 of each user and accumulates the same, analyzes the content, and automatically delivers the content to the appropriate delivery destination according to the analysis result. The server 30 may be configured by a server device or may be configured by a virtual server in a cloud computing environment. For example, the collecting and delivering server 30 includes each unit of a biological information collecting unit 31, a biological information analyzing unit 32, a distribution determining unit 33, an analyzing information delivering unit 35, and the like mounted by software. Furthermore, the server 30 includes each table of biological information TB36, analyzing information TB37, and the like mounted by database, file table, and the like.

The biological information collecting unit 31 carries out a process of receiving the biological information 13 transmitted from each biological information transferring device 20 and recording and accumulating the biological information in the biological information TB36. The biological information analyzing unit 32 processes the biological information 13 newly recorded in the biological information TB36 by carrying out four arithmetic operations, statistical process, and the like at a predetermined timing to convert the information to a meaningful analyzing information, and records such information in the analyzing information TB37. Here, the predetermined timing may be, for example, the timing the instruction from the user such as the administrator is received, the predefined interval, the timing the event of recording the new biological information 13 in the biological information TB 36 occurred, and the like. The processing content of converting the biological information 13 may differ depending on the type of biological information 13, but for example, includes performing root mean square with respect to the values in each axial direction of the three-dimensional acceleration sensor to calculate a relative index value indicating the strength of activity, as will be described later.

The distribution determining unit 33 carries out a process of determining the analyzing information display device 40 to become the delivery destination according to the content of a distribution rule 34 defined in advance for the information of the analysis result recorded in the analyzing information TB37. As will be described later, the distribution rule 34 is set in advance with the analyzing information display device 40 to become the delivery destination at normal time, the setting of the analyzing information display device 40 to become the additional delivery destination at abnormal time, condition for determining that the analysis result of the biological information 13 is abnormal and the like. The determination criterion of the delivery destination is not limited to whether the analysis result of the biological information 13 is normal or abnormal, and other conditions may be set. The analyzing information delivering unit 35 carries out a process of transmitting the information of the analysis result to the analyzing information display device 40 to become the delivery destination determined by the distribution determining unit 33.

The analyzing information display device 40 is a server system possessed by people and organizations that reference the analysis result information for the biological information, that is, specialized institutions and business operators (e.g., healthcare facility, care service business operator, etc.) that provide services such as various types of management, monitoring, and the like for the health state, the life situation, and the like based on the information of the analysis result. Similar to the collecting and delivering server 30, the analyzing information display device 40 may be configured by a server device or may be configured by a virtual server in a cloud computing environment. The analyzing information display device 40 includes, for example, each unit of an input/output unit 41, an analyzing information receiving unit 42, and an analyzing unit 43 mounted by software. The device 40 also includes a table of analyzing information TB44, and the like mounted by database, file table, and the like.

The input/output unit 41 carries out a process of receiving the operation instruction from the user and displaying the content, and the like of the analyzing information TB44 with respect to the user. For such processes, the input/output unit 41 may carry out input/output through the Web browser, and the like (not shown) on a display terminal 50 including the information processing device such as the PC connected through the network such as LAN (Local Area Network) and including a Web server program (not shown).

The analyzing information receiving unit 42 carries out a process of receiving the analyzing information transmitted from the collecting and delivering server 30, and storing the same in the analyzing information TB44. The analyzing unit 43 carries out processes of further performing the analysis, as needed, with respect to the analyzing information accumulated in the analyzing information TB44 or processing the data. If the analyzing information corresponds to the condition defined in advance, for example, notification, warning, and the like are made on the display terminal 50 through the input/output unit 41 to urge the user to take actions or measures.

### <Data Configuration>

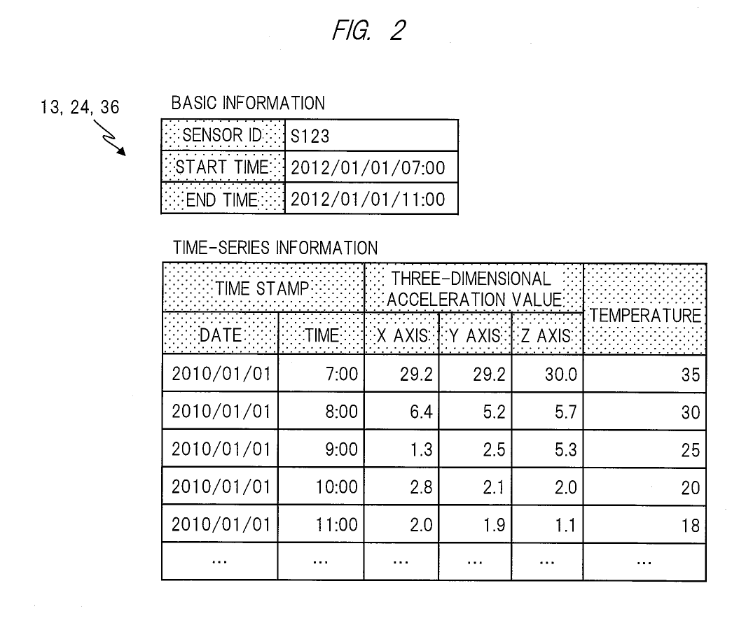

FIG. 2 is a view showing an outline of an example of a data configuration of the biological information TB24, 36 (and biological information 13) and specific data in the present embodiment. The biological information TB24, 36 is a table holding the content of various types of biological information acquired by the sensor 10, and is divided to basic information and time-series information.

The basic information is management information held for each sensor 10, and for example, includes each item of sensor ID, start time, and end time. The sensor ID item holds the ID information with which each sensor can be uniquely identified. Each item of start time and end time holds the items of a start time and an end time specifying a temporal range of the data acquired by the target sensor included in the biological information.

The time-series information is information in which the content of the biological information acquired by the target sensor 10 is accumulated in time-series, and for example, includes each time of time stamp, three-dimensional acceleration value, and temperature. The time stamp item holds the information of the time stamp when the target biological information is acquired. In the example of FIG. 2, the information is held separately for date and for time.

The three-dimensional acceleration value holds the information of the measurement value by the three-dimensional accelerations sensor of the target sensor 10. In the example of FIG. 2, the information is divided to acceleration values in the X-axis, Y-axis, and Z-axis directions, and holds the value in which the output value of the three-dimensional acceleration sensor capable of measuring up to ±5G is represented with eight bits (−124 to +124). The temperature item holds the information of the measurement value by the temperature sensor of the target sensor 10. In the example of FIG. 2, the value in which the measurement values of 0° C. to 64° C. are represented with six bits (0 to 64) is held. Although the sensor 10 is configured to include only the sensors for the three-dimensional acceleration and the temperature in the present embodiment, if a sensor capable of acquiring other biological information is arranged, the measurement value of such sensor is also to be held.

FIG. 3 is a view showing an outline of an example of a data configuration of the analyzing information TB 37, 44 and the specific data in the present embodiment. The analyzing information TB37, 44 is a table holding data converted to meaningful analyzing information by processing the various types of biological information acquired by the sensor 10 and accumulated in the biological information TB36 of the collecting and delivering server 30 through four arithmetic operations, statistical processing and the like, and are divided to the basic information and the time-series information.

The basic information is management information held for each sensor 10, and for example, includes each item of sensor ID, start time, end time, and delivery destinations 1, 2. Each item of the sensor ID, the start time, and the end time are the same content as the corresponding items of the basic information in the biological information TB24, 36 shown in FIG. 2.

The item of delivery destinations 1, 2 holds the information specifying the analyzing information display device 40 to become the delivery destination of the analyzing information for the biological information acquired by the target sensor 10. In the example of FIG. 3, the delivery destination 1 is the delivery destination at the normal time, and the delivery destination 2 holds the information of the additional delivery destination when the analyzing information has a predetermined abnormality. Candidates such as delivery destinations 3, 4, . . . may be increased. The information of the delivery destinations 1, 2 is registered as a blank (unknown) state at the time of new storage of the analyzing information, and thereafter, the delivery destination is set based on the determination result of the distribution determining unit 33 with respect to the analyzing information. Various types of information such as a sever name (e.g., host name, etc.), an IP address, and the like, for example, can be appropriately used for the information specifying the analyzing information display device 40 of the delivery destination.

The time-series information is information in which the content of the analyzing information for the biological information acquired by the target sensor 10 is accumulated in time-series, and for example, includes each item of time stamp, activity amount, and temperature. The items of time stamp and temperature are the same content as the corresponding items of the time-series information in the biological information TB24, 36 shown in FIG. 2. The item of activity amount holds a result of performing, for example, a root mean square on a three-dimensional acceleration value of the biological information accumulated in the biological information TB36 to calculate as a relative index value indicating the magnitude of activity. Specifically, assuming the acceleration in the X axis, the Y axis, and the Z axis are X1, Y1, Z1, the activity amount A1 is obtained, for example, with the following equation.

A1=√(X1²+Y1²+X1²) equation (1)

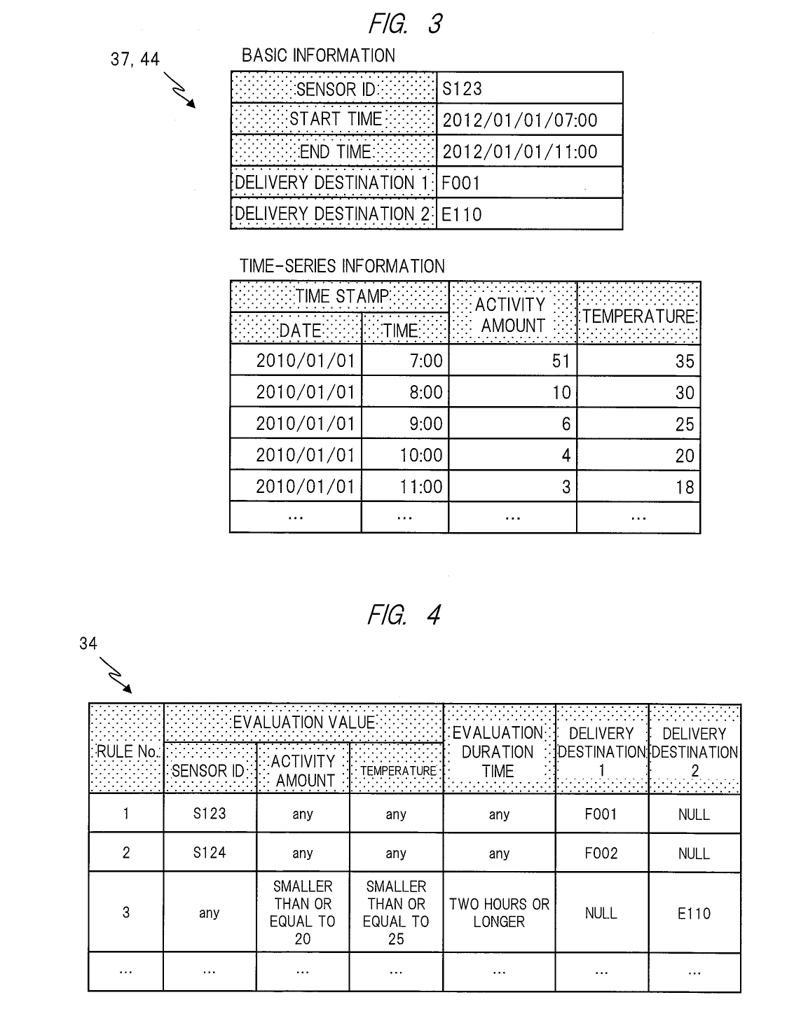

FIG. 4 is a view showing an outline of an example of a data configuration of the distribution rule 34 and the specific data in the present embodiment. The distribution rule 34 is a table holding the information of the delivery destination when an evaluation criteria (condition) of the value of the analysis result of when distributing the analyzing information to the analyzing information display device 40 and the information of the delivery destination of when corresponding to each criteria for the analyzing information recorded in the analyzing information TB37 shown in FIG. 3, and includes, for example, each item of rule No., evaluation value, evaluation duration time, and delivery destinations 1, 2.

The rule No. item holds the information of a number given to each rule. The evaluation value item holds the information (e.g., “smaller than or equal to 20”, etc.) of the evaluation value to become the determination criteria in the distribution for each item in the analyzing information recorded in the analyzing information TB37. In the present embodiment, the item of the analyzing information includes items of sensor ID, activity amount, and temperature, and determination is made that the rule is relevant if all the criteria of the evaluation value specified with respect to such items are satisfied (the rule is not relevant if even one of the criteria is not met). The symbol “any” is specified for the evaluation value if the determination criteria of the distribution are not met for each of the items. When taking other types of biological information into consideration, the item of the evaluation value to become the determination criteria can be increased according to the type.

The item of the evaluation duration time holds the determination criteria (e.g., “two hours or longer”, etc.) for the duration time in a state all the criteria of the evaluation value specified with respect to the each of the items are met when the evaluation value to become the determination criteria is set (not “any”) to the items other than the sensor ID in each item of the evaluation item described above. In other words, if a state in which the criteria of the evaluation value specified for each item is met is continued for a time specified to the item of the evaluation duration time, determination is made that the target rule is relevant.

The item of the delivery destinations 1, 2 respectively holds the information specifying the analyzing information display device 40 to deliver the target analyzing information when the target rule is relevant. In the present embodiment, the delivery destination to be steadily delivered (regardless of whether in the normal state or the abnormal state) according to the sensor ID is set for the delivery destination 1 (e.g., record of rule No.=“1”, “2”, etc. in the example of FIG. 4), and the delivery destination to be additionally delivered when the evaluation value is in an abnormal or special state is set for the delivery destination 2 (e.g., record of rule No.=“3”, etc. in the example FIG. 4). If a special character (“NULL” in the example of FIG. 4) is set for the item of the delivery destination, this means that the delivery destination is indefinite (not to be delivered).

As will be described later, each rule set in the distribution rule 34 is independently evaluated. In the example of FIG. 4, for example, “F001” is set to the delivery destination 1 since the analyzing information of sensor ID “S123” automatically corresponds to the determination criteria of the rule No. =“1”. Furthermore, if the determination criteria of rule No. =“3” is also met, the information of the delivery destination 1 is controlled so as not to be overwritten from “F001” to “NULL”. On the other hand, the delivery destination 2 is controlled so as to be overwritten from “NULL” to “E110”.

The data configuration (items) of each table shown in FIGS. 2 to 4 is merely an example, and other table configurations and data structures may be adopted as long as similar data can be held and managed. A table for holding other information, as needed, may be arranged. For example, in the collecting and delivering server 30, a user master table for managing the information of the user to become the target of acquiring and analyzing the biological information, a delivery destination master table for managing the information of the analyzing information display device 40 to become the delivery destination and the organizations, business operators, and the like including the same, may be arranged.

### <Flow of Processes>

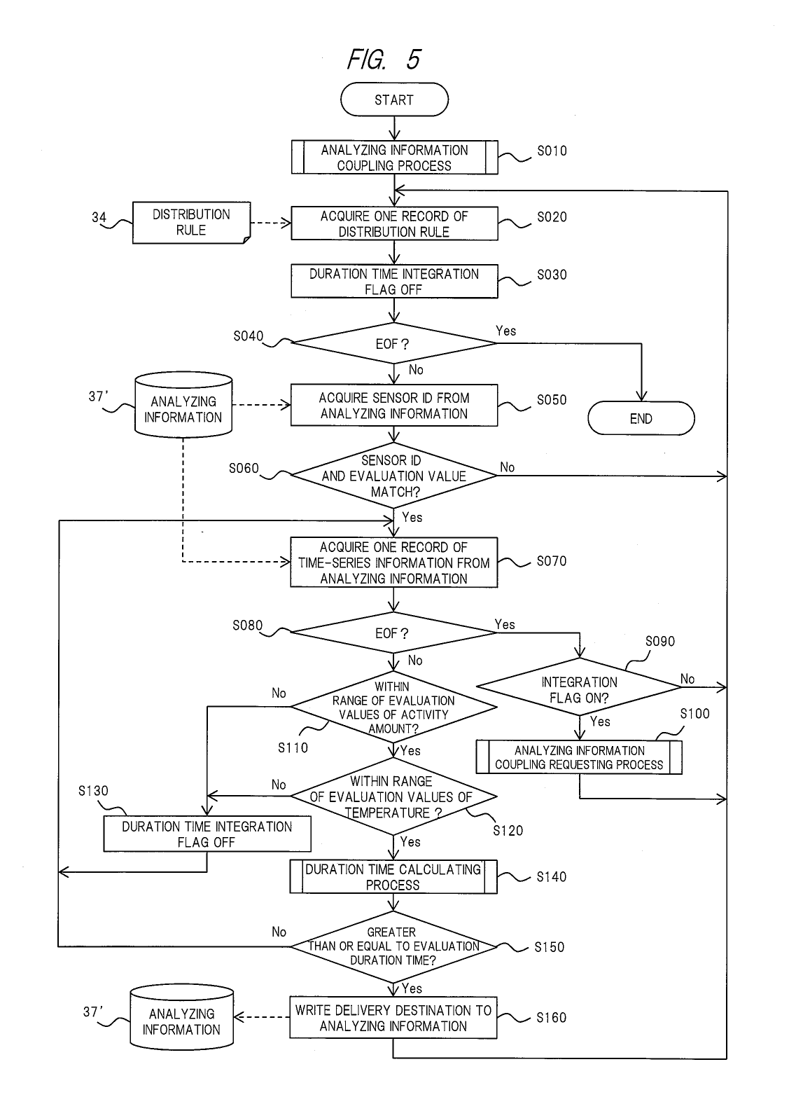

FIG. 5 is a flowchart showing the outline of an example of the flow of the determination process of the delivery destination of the analyzing information in the distribution determining unit 33 of the collecting and delivering server 30, which is a characteristic process in the present embodiment. With a new piece of analyzing information accumulated in the analyzing information TB37 by the biological information analyzing unit 32, the distribution determining unit 33 first carries out an analyzing information coupling process of coupling a new piece of analyzing information, which is the target of the relevant process, and the past (previous process) analyzing information as a preparation process (S010). This process is carried out to enable a continuous determination on whether or not the item of the evaluation duration time set in each rule of the distribution rule 34 is met from the previous process. The content of the analyzing information coupling process will be described later.

Next, one record is acquired from the distribution rule 34 (S020), and an integration flag for calculating the duration time is set (reset) to OFF (S030). The integration flag is a flag set to ON while being continued to integrate and calculate the time in which the state all the criteria of the evaluation values specified in each rule of the distribution rule 34 are met is continued. Thereafter, whether or not the record acquired in step S020 is the final record (EOF) is determined (S040), and the process is terminated if the record is EOF.

If the record is not the EOF, the sensor ID of the basic information is acquired from the analyzing information 37′ to be processed (S050), and whether or not the acquired sensor ID matches the evaluation value of the sensor ID in the rule acquired in step S020 is determined (S060). If the ID does not match, the process returns to step S020, and the next record of the distribution rule 34 is acquired and the processes are repeated.

On the other hand, if the ID matches, one record of the time-series information is acquired from the analyzing information 37′ to be processed (S070), and whether or not the acquired record is the final record (EOF) is determined (S080). If the acquired record is the EOF, whether or not the integration flag for calculating the duration time is ON is determined (S090). If the integration flag is OFF, the duration time is not being integrated, and thus the process returns to step S020, and the next record of the distribution rule 34 is acquired and the processes are repeated. On the other hand, if the integration flag is ON, the duration time is being integrated and thus the information becomes the target of the analyzing information coupling process of step S010 in the next determination process, and thus the analyzing information coupling requesting process is carried out (S100) and then the process returns to step S020. The content of the analyzing information coupling requesting process will be described later.

If the acquired record is not the EOF in step S080, whether or not the value of the activity amount of the record (time-series information) of the acquired analyzing information 37′ is within a range of the evaluation values of the activity amount in the rule acquired in step S020 (whether the condition is met) is determined (S110). If the value is within the range of the evaluation values of the activity amount, whether or not the value of the temperature of the record (time-series information) of the acquired analyzing information 37′ is within the range of the evaluation values of the temperature in the rule acquired in step S020 (condition is met) is determined next (S120).

If the value is not within the range of the evaluation values in at least one of step S110 or S120, this means that the state in which all the criteria of the evaluation value specified in the rule acquired in step S020 are met is not continued. Thus the integration flag for integrating the duration time is set (reset) to OFF (S130), the process returns to step S070, and the next record of the time-series information is acquired from the analyzing information 37′ to be processed and the processes are repeated. On the other hand, if the value is within the range of the evaluation values in both steps S110 and S120, this means that the state in which all the criteria of the evaluation value specified in the rule acquired in step S020 are met is continued (or newly started), and thus a duration time calculating process of calculating the duration time is carried out (S140). The content of the duration time calculating process will be described later.

Thereafter, whether or not the calculated duration time is continued for greater than or equal to a value of the evaluation duration time specified in the rule acquired in step S020 (condition is met) is determined (S150). If not continued for greater than or equal to the value of the evaluation duration time, this means that the condition of the rule acquired in step S020 is not yet met, and thus the process returns to step S070, and the next record of the time-series information is acquired from the analyzing information 37′ to be processed and the processes are repeated. On the other hand, if continued for greater than or equal to the value of the evaluation duration time, the information of the delivery destinations 1, 2 set in the rule acquired in step S020 is written to the basic information of the analyzing information 37′ acquired in step S050 (S160), and the process returns to step S020 and the next record of the distribution rule 34 is acquired and the processes are repeated.

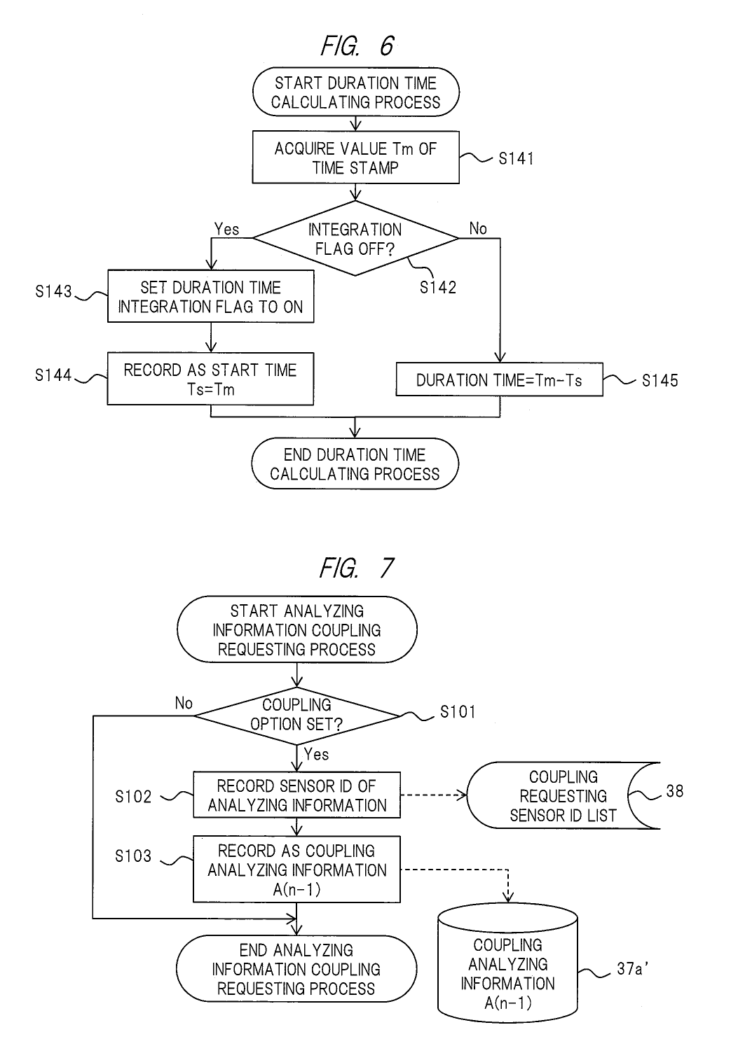

FIG. 6 is a flowchart showing an outline of an example of the flow of the duration time calculating process (step S140) in the process flow of FIG. 5. First, a value Tm of a time stamp of the record (time-series information) of the analyzing information 37′ acquired in step S070 of FIG. 5 is acquired (S141), and then whether or not the integration flag for integrating the duration time is set to OFF is determined (S142).

If the integration flag is set to OFF, the integration flag is set to ON to start the integration of the duration time (S143), the value of Tm acquired in step S141 is recorded in the memory, and the like as the start time Ts of duration (S144), and the process is terminated. On the other hand, if the integration time is set to ON in step S142, a difference Tm-Ts of the value of the Tm acquired in step S141 and the start time Ts recorded in step S144 is calculated as the duration time (S145), and the process is terminated.

FIG. 7 is a flowchart showing an outline of an example of the flow of the analyzing information coupling requesting process (step S100) in the process flow of FIG. 5. First, whether or not an option setting of permitting the calculation of the duration time after coupling the data in the determination process of the next delivery destination is made is determined for the final record (time-series information) of the analyzing information 37′ acquired in step S070 of FIG. 5 (S101). The setting of the coupling option can be specified in advance in the setting file and the like (not shown) on the collecting and delivering server 30, for example.

If the coupling option is not set, the process is terminated as is, whereas if the coupling option is set, the sensor ID is acquired from the basic information of the analyzing information 37′ acquired in step S050 of FIG. 5, and such sensor ID is recorded in a coupling requesting sensor ID list 38 as the coupling requesting sensor ID (S102). For example, the coupling requesting sensor ID list 38 can be held as a table and the like in the file and the memory, for example. Thereafter, the content of the basic information of the analyzing information 37′ acquired in step S050 of FIG. 5 and each record (time-series information) of the analyzing information 37′ acquired in step S070 is recorded as the coupling analyzing information A(n−1)(37a′) to become the data to be coupled in the determination process of the next delivery destination (S103), and the process is terminated.

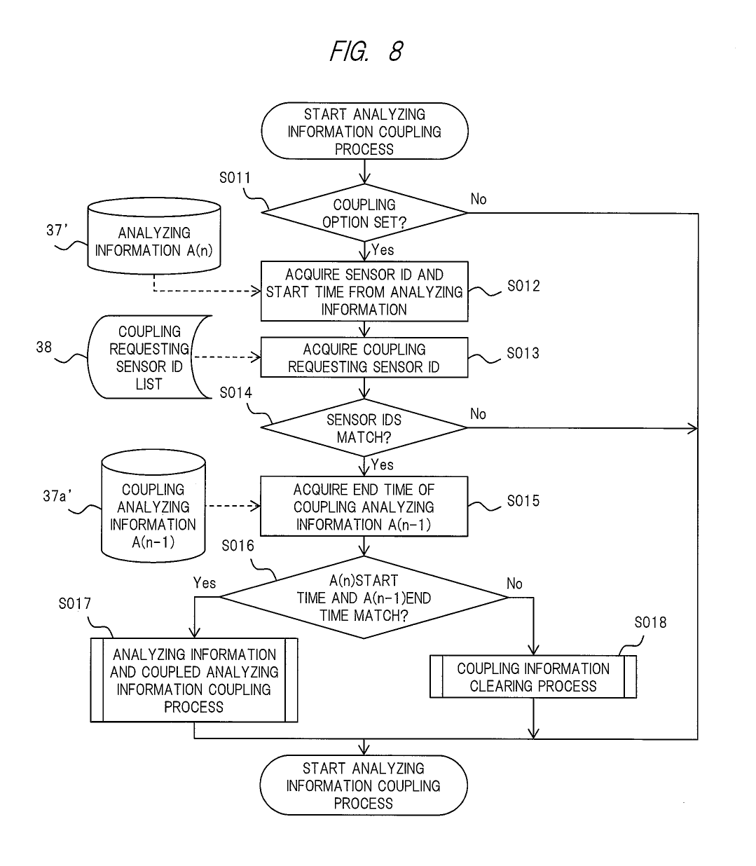

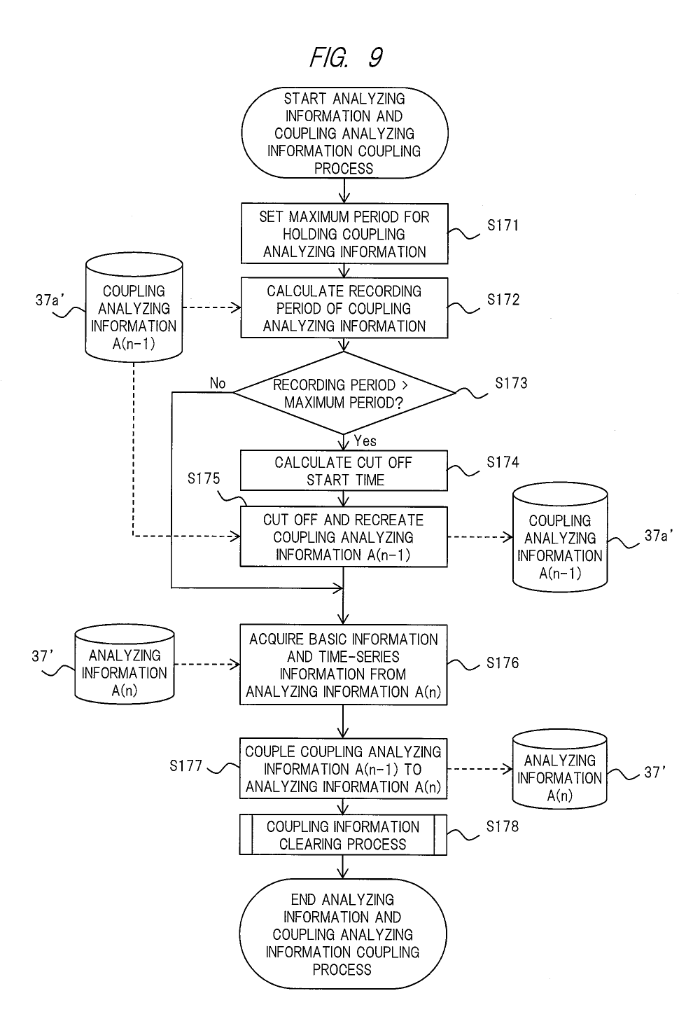

FIG. 8 is a flowchart showing an outline of an example of a flow of the analyzing information coupling process (step S010) in the process flow of FIG. 5. First, whether or not the coupling option is set is determined, similar to step S101 of FIG. 7 (S011). If the coupling option is not set, the process is terminated as is. On the other hand, if the coupling option is set, the sensor ID and the start time of the basic information are acquired from the analyzing information A(n) (37′) to be processed (S012), and furthermore, each coupling requesting sensor ID is acquired from the coupling requesting sensor ID list 38 created and updated in step S102 of FIG. 7 in the determination process of the previous delivery destination (S013).

Next, whether or not the sensor ID acquired in step S012 matches any of the coupling requesting sensor IDs acquired in step S013 is determined (S014). If there is no match, the process is terminated as is. On the other hand, if there is a match, the end time of the basic information is acquired from the coupling analyzing information A(n−1)(37a′) recorded in step S103 of FIG. 7 in the determination process of the previous delivery destination (S015). Thereafter, whether or not the acquired end time matches the start time of the analyzing information A(n) (37′) acquired in step S012, that is, whether or not the analyzing information is successively recorded is determined (S016).

If the end time and the start time match, the analyzing information are assumed to be continuous, and the analyzing information and coupling analyzing information coupling process of coupling the analyzing information is carried out (S017), and the process is terminated. The content of the analyzing information and coupling analyzing information coupling process will be described later. On the other hand, if the end time and the start time do not match in step S016, the analyzing information are assumed to be not continuous, and the coupling information clearing process of clearing the coupling information (coupling requesting sensor ID list 38 and coupling analyzing information A(n−1) (37′a)) recorded in the determination process of the previous delivery destination is carried out (S018), and the process is terminated. The content of the coupling information clearing process will be described later.

FIG. 9 is a flowchart showing an outline of an example of a flow of the analyzing information and coupling analyzing information coupling process (step S017) in the process flow of FIG. 8. First, a maximum period Dmax for holding the coupling analyzing information A(n−1)(37a′)is set (S171). For example, the value of 1.2 times and the like is calculated taking into consideration the margin with respect to the value of the evaluation duration time in the record of the distribution rule 34 acquired in step S020 of FIG. 5 to obtain Dmax.

Next, the recording time of the coupling analyzing information A(n−1)(37a′) is calculated based on the content of the target coupling analyzing information A(n−1)(37a′) (S172). Specifically, the start time and the end time are acquired from the basic information of the coupling analyzing information A(n−1)(37a′), and the end time—start time is assumed as the recording time. Thereafter, whether or not the calculated recording time is greater than the maximum period Dmax set in step S171 is determined (S173). If the recording time is smaller than or equal to Dmax, the process proceeds to step S176.

On the other hand, if the recording time is greater than Dmax, the cut off start time to become a reference in deleting the information before the predetermined period in the coupling analyzing information A(n−1)(37a′) is calculated (S174). Specifically, the time (end time—Dmax) of before the end time of the coupling analyzing information A(n−1) (37a′) acquired in step S172 by the maximum period Dmax set in step S171 is assumed as the cut off start time.

Thereafter, the information in which the time stamp of the time-series information is before the cut off start time in the coupling analyzing information A(n−1)(37a′) is deleted (cut off), and the time stamp of the record (oldest record) in which the time stamp is immediately after the cut off start time of the remaining time-series information is acquired and set to the start time of the basic information of the coupling analyzing information A(n−1)(37a′) to recreate the coupling analyzing information A(n−1)(37a′) in the cut off state (S175).

Next, the basic information and the time-series information are acquired from the analyzing information A(n)(37′) to be processed (S176). Subsequently, the time-series information of the coupling analyzing information A(n−1)(37a′) (the recreated information if the information is cut off and recreated in step S175) are coupled (merged) in time-series order with respect to the acquired analyzing information A(n) to obtain the new analyzing information A(n) (37′) (S177). At this time, the value of the start time of the basic information of the analyzing information A(n)(37′) is reset with the value of the start time of the basic information of the original coupling analyzing information AA(n−1)(37a′). Thereafter, the coupling information clearing process of clearing the coupling information (coupling requesting sensor ID list 38 and coupling analyzing information A(n−1)(37a′)) is carried out (S178), and the process is terminated. The content of the coupling information clearing process will be described later.

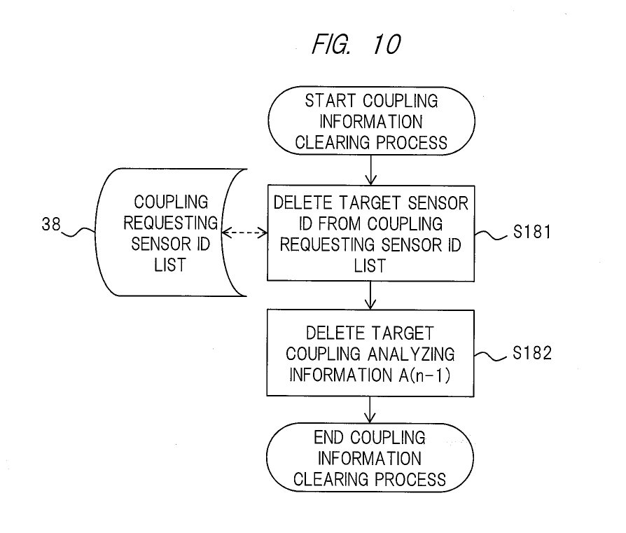

FIG. 10 is a flowchart showing an outline of an example of a flow of the coupling information clearing process (steps S018 and S178) in the process flow of FIGS. 8 and 9. First, the sensor ID to be processed is deleted from the coupling requesting sensor ID list 38 created and updated in step S102 of FIG. 7 in the determination process of the previous delivery destination (S181). Thereafter, the coupling analyzing information A(n−1)(37a′) (include case recreated in step S175 of FIG. 9 in the determination process of the delivery destination of this time) created in step S103 of FIG. 7 in the determination process of the previous delivery destination is deleted (S182), and the process is terminated.

According to the series of processes described above, even if the collecting and analyzing processes of the biological information 13 are intermittently carried out, the intermittently created analyzing information is handled as successive data, the duration time of when the criteria of the evaluation value is met is calculated, and the delivery destination of the analyzing information can be determined.

As described above, according to the biological information collecting and delivering system 1 of one embodiment of the present invention, the biological information acquiring device (sensor) 10 including a sensor that can acquire a plurality of pieces of biological information is attached to each user, the obtained biological information 13 is aggregated in an integrated fashion in the collecting and delivery server 30, each piece of biological information 13 is analyzed on the collecting and delivering server 30 to grasp the index for the health state, the activity situation, and the like, and the information is delivered to the analyzing information display device 40 of the person, organization, and the like requiring the information at an appropriate timing based on the analysis result.

In the foregoing, the invention made by the inventors of the present invention has been concretely described based on the embodiments. However, it is needless to say that the present invention is not limited to the foregoing embodiments and various modifications and alterations can be made within the scope of the present invention. For example, the embodiment described above has been described in detail to facilitate the understanding of the present invention, and is not necessarily limited to including all configurations described herein. Furthermore, other configurations may be added, deleted, and substituted with respect to some of the configurations of the embodiment described above.

The information such as the program, table, file, and the like for realizing each function can be loaded in a recording device such as a memory, a hard disc, a SSD (Solid State Drive), and the like, or a recording medium such as an IC card, an SD card, a DVD, and the like. In each figure described above, the control line and the information line considered necessary for the explanation are shown, and all control lines and information lines that are mounted may not necessarily be shown. Substantially all the configurations are, actually, assumed to be mutually connected.

The present invention can be used for the biological information collecting and delivering system that collects the biological information of a plurality of users and manages the state of each user in an integrated fashion.

While the present invention has been illustrated and described with respect to a particular embodiment there of, it should be appreciated by those of ordinary skill in the art that various modifications to this invention may be made without departing from the spirit and scope of the present.

What is claimed is:

1. A biological information collecting and delivering system comprising:
a biological information acquiring device attached to a user to acquire biological information of the user;
a biological information transferring device that acquires the biological information from one or more biological information acquiring devices and records the biological information;
a collecting and delivering server that collects the biological information from one or more biological information transferring devices and records the biological information, analyzes the recorded biological information, and records the analyzing information for every biological information acquiring device; and
an analyzing information display device that receives and records the analyzing information delivered from the collecting and delivering server, and presents the analyzing information to a user; wherein
the collecting and delivering server includes,
a distribution rule including a determination criteria of a value of an analysis result for every type of biological information contained in the analyzing information, and information of one or more analyzing information display devices to become a destination for delivering the analyzing information when all of the determination criteria are met, and
a distribution determining unit for determining the analyzing information display device to deliver the analyzing information based on a value for every type of biological information contained in the analyzing information and the distribution rule.

2. The biological information collecting and delivering system according to claim 1, wherein
the distribution rule in the collecting and delivering server includes identification information of the biological information acquiring device contained in the analyzing information and the information of the one or more analyzing information display devices to become a destination for delivering the analyzing information specified by the identification information; and
the distribution determining unit determines the analyzing information display device to deliver the analyzing information based on the identification information of the biological information acquiring device contained in the analyzing information and the distribution rule.

3. The biological information collecting and delivering system according to claim 1, wherein
the distribution rule in the collecting and delivering server includes a condition of a duration time of a state in which a value for every type of the biological information contained in the analyzing information meets all the corresponding determination criteria specified in the distribution rule, and the information of one or more analyzing information display devices to become a destination for delivering the analyzing information when the condition is met; and
the distribution determining unit determines the analyzing information display device to deliver the analyzing information based on the information of the duration time of the state in which the value for every type of biological information contained in the analyzing information meets all the corresponding determination criteria specified in the distribution rule and the distribution rule.

4. The biological information collecting and delivering system according to claim 3, wherein
the distribution determining unit in the collecting and delivering server holds first analyzing information when the analyzing information display device to deliver the first analyzing information is determined, and carries out a determination after coupling all or a part of the held first analyzing information in time series to second analyzing information when determining the analyzing information display device to deliver the second analyzing information next time.

5. The biological information collecting and delivering system according to claim 2, wherein
the distribution rule in the collecting and delivering server includes a condition of a duration time of a state in which a value for every type of the biological information contained in the analyzing information meets all the corresponding determination criteria specified in the distribution rule, and the information of one or more analyzing information display devices to become a destination for delivering the analyzing information when the condition is met; and
the distribution determining unit determines the analyzing information display device to deliver the analyzing information based on the information of the duration time of the state in which the value for every type of biological information contained in the analyzing information meets all the corresponding determination criteria specified in the distribution rule and the distribution rule.
